(19) United States
(12) Patent Application Publication
(10) Pub. No.: US 2016/0001493 A1
(43) Pub. Date: Jan. 7, 2016

(54) IMPRINT APPARATUS, IMPRINT SYSTEM, AND METHOD OF MANUFACTURING ARTICLE

(71) Applicant: CANON KABUSHIKI KAISHA, Tokyo (JP)

(72) Inventors: Yutaka Mita, Utsunomiya-shi (JP); Yoshikazu Miyajima, Utsunomiya-shi (JP); Tsuyoshi Arai, Utsunomiya-shi (JP)

(21) Appl. No.: 14/754,944

(22) Filed: Jun. 30, 2015

(30) Foreign Application Priority Data
Jul. 1, 2014 (JP) 2014-136214

(51) Int. Cl. B29C 59/00

(52) U.S. Cl. CPC B29C 59/002; B29L 2007/001

(57) ABSTRACT

The present invention provides an imprint apparatus which performs an imprint process of dispensing an imprint material on a substrate and forming the imprint material dispensed on the substrate by using a mold, the apparatus comprising a dispensing unit configured to dispense an imprint material on the substrate, and including a tank which contains an imprint material, a dispenser which discharges the imprint material contained in the tank to the substrate, and a detection unit which detects a remaining amount of imprint material contained in the tank; and a control unit configured to perform control to supply an imprint material to the tank or exchange the dispensing unit based on a detection result obtained by the detection unit.

### BACKGROUND OF THE INVENTION

1. Field of the Invention

The present invention relates to an imprint apparatus, an imprint system, and a method of manufacturing an article.

2. Description of the Related Art

An imprint apparatus which forms an imprint material on a substrate by using a mold has attracted attention as a mass-production lithography apparatus for magnetic storage media, semiconductor devices, and the like. Japanese Patent Laid-Open No. 2013-251462 has proposed an imprint apparatus including a dispensing unit which dispenses an imprint material on a substrate. The imprint apparatus disclosed in Japanese Patent Laid-Open No. 2013-251462 performs, for each of a plurality of shot regions on a substrate, an imprint process of dispensing an imprint material on the substrate by using a dispensing unit and forming the imprint material dispensed on the substrate by using a mold.

If a shortage of an imprint material occurs during the repetition of an imprint process for one substrate or one lot, the imprint process can be interrupted. In this case, it can be difficult to accurately form patterns formed from the imprint material throughout one substrate or one lot. For this reason, the imprint apparatus may operate based on the remaining amount of imprint material contained in a tank. Japanese Patent Laid-Open No. 2013-251462 describes nothing about the detection of the remaining amount of imprint material contained in a tank or any operation based on the remaining amount of imprint material.

### SUMMARY OF THE INVENTION

The present invention provides a technique advantageous in accurately forming, for example, patterns formed from an imprint material.

According to one aspect of the present invention, there is provided an imprint apparatus which performs an imprint process of dispensing an imprint material on a substrate and forming the imprint material dispensed on the substrate by using a mold, the apparatus comprising: a dispensing unit configured to dispense an imprint material on the substrate, and including a tank which contains an imprint material, a dispenser which discharges the imprint material contained in the tank to the substrate, and a detection unit which detects a remaining amount of imprint material contained in the tank; and a control unit configured to perform control to supply an imprint material to the tank or exchange the dispensing unit based on a detection result obtained by the detection unit.

Further features of the present invention will become apparent from the following description of exemplary embodiments with reference to the attached drawings.

### BRIEF DESCRIPTION OF THE DRAWINGS

FIG. 1 is a schematic view showing an imprint apparatus according to the first embodiment;

FIG. 2 is a schematic view showing the arrangement of an imprint unit;

FIG. 3 is a view showing a cross-section of a dispensing unit;

FIG. 4 is a view showing how a driving unit drives the dispensing unit;

FIG. 5 is a view showing how a supply unit supplies an imprint material;

FIGS. 6A to 6C are views showing how an exchanging unit exchanges a dispensing unit;

FIG. 7A is a view for explaining a procedure for an imprint process;

FIG. 7B is a view for explaining a procedure for an imprint process;

FIG. 7C is a view for explaining a procedure for an imprint process;

FIG. 7D is a view for explaining a procedure for an imprint process;

FIG. 8A is a view for explaining a procedure for an imprint process;

FIG. 8B is a view for explaining a procedure for an imprint process; and

FIG. 8C is a view for explaining a procedure for an imprint process.

### DESCRIPTION OF THE EMBODIMENTS

Exemplary embodiments of the present invention will be described below with reference to the accompanying drawings. Note that the same reference numerals denote the same members throughout the drawings, and a repetitive description thereof will not be given.

### First Embodiment

An imprint apparatus 100 according to the first embodiment will be described. The imprint apparatus 100 is used for the manufacture of semiconductor devices and the like. The imprint apparatus 100 performs an imprint process of dispensing an imprint material on a substrate and forming the imprint material dispensed on the substrate by using a mold. For example, the imprint apparatus 100 cures an imprint material (resin) on a substrate while a mold 5 on which a pattern is formed is in contact with the imprint material. The imprint apparatus 100 then can form, on a substrate 1, the pattern formed from the imprint material by separating (releasing) the cured imprint material from the mold 5 upon increasing the interval between the mold 5 and the substrate 1. Methods of curing imprint materials include a heat cycle method using heat and a photo-curing method using light. The first embodiment will exemplify a case using the photo-curing method. The photo-curing method is a method of curing an uncured ultraviolet curable resin as an imprint material by supplying the imprint material on a substrate and irradiating the imprint material with ultraviolet light while the mold 5 is in contact with the imprint material.

The imprint apparatus 100 (imprint system) according to the first embodiment can include an imprint unit 10 (imprint apparatus), a forming unit 14 (forming apparatus), a supply unit 15, an exchanging unit 16, and a control unit 17. The imprint unit 10 includes a dispensing unit 7 which dispenses an imprint material on a substrate, and performs an imprint process of dispensing an imprint material on a substrate by using the dispensing unit 7 and forming the imprint material on the substrate by using the mold 5 on which a pattern is formed. Assume that in the following description, an imprint process includes a dispensing process of dispensing an imprint material on the substrate 1 by using the dispensing unit 7 and a forming process of forming the imprint material dispensed on the substrate by using the mold 5. The forming unit 14 performs a forming process of forming, on a substrate, an adhesion layer for making the substrate 1 adhere to an imprint material. The supply unit 15 performs a process of supplying an imprint material to a tank 7a of the dispensing unit 7. The exchanging unit 16 performs a process of exchanging the dispensing unit 7. The control unit 17 includes, for example, a CPU and a memory, and controls the respective units of the imprint apparatus 100.

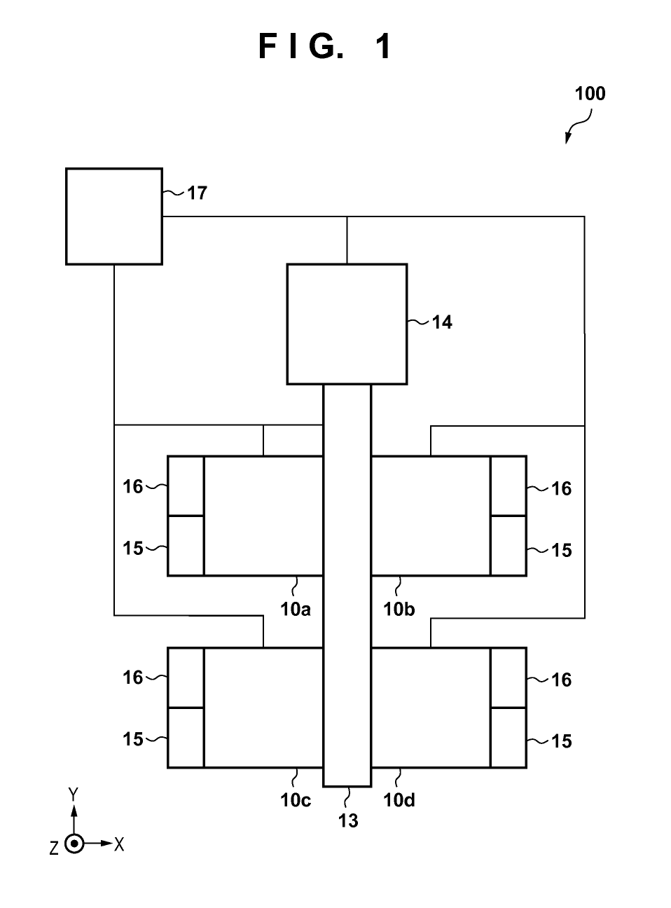

The first embodiment will exemplify a case in which the imprint apparatus 100 includes a plurality of (four) imprint units 10a to 10d and one forming unit 14, as shown in FIG. 1. In this case, a conveying unit 13 conveys substrates on which adhesion layers are formed by the forming unit 14 to the respective imprint units 10a to 10d. In the first embodiment, the imprint apparatus 100 can include one supply unit 15 and one exchanging unit 16 for each of the imprint units 10a to 10d. However, the imprint apparatus 100 is not limited to the arrangement shown in FIG. 1. For example, the imprint apparatus 100 may be configured to include one each of the imprint unit 10 and the forming unit 14 or may be configured to provide one supply unit 15 and one exchanging unit 16 commonly for two or more imprint units 10.

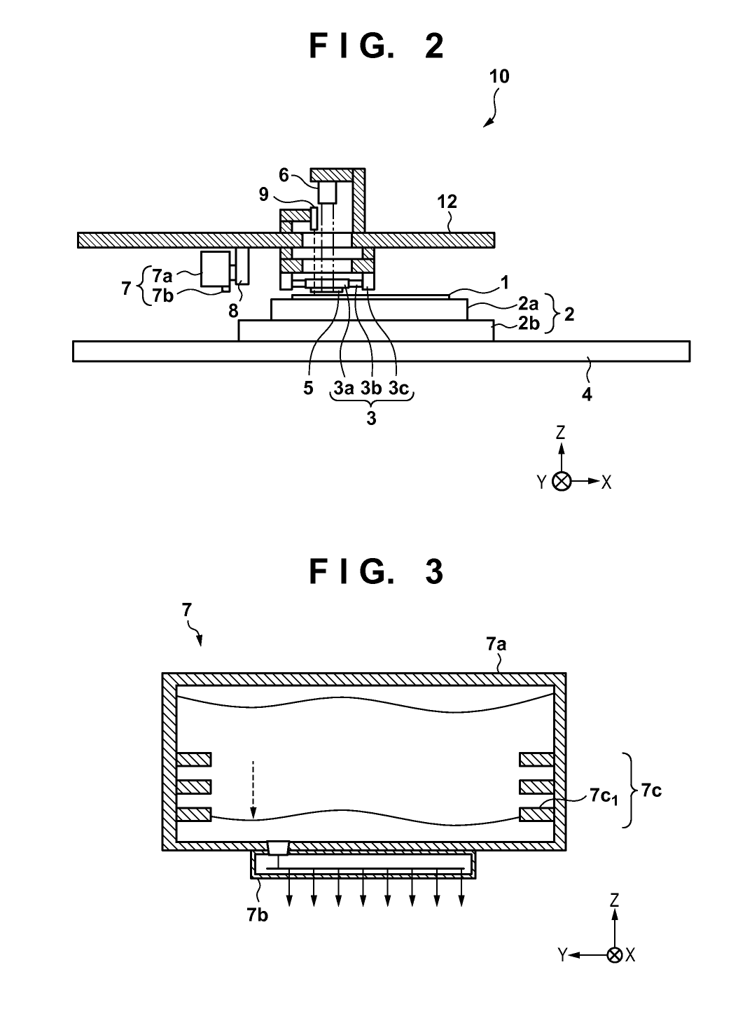

The arrangement of the imprint unit 10 will be described with reference to FIG. 2. FIG. 2 is a schematic view showing the arrangement of the imprint unit 10. The imprint unit 10 can include an imprint head 3 which holds the mold 5, an irradiation unit 6 including a light source which emits light (ultraviolet light), the dispensing unit 7 which dispenses an imprint material on a substrate, and an alignment measurement unit 9 which measures the relative positions of the mold 5 and the substrate 1. In addition, the imprint unit 10 can include a substrate stage 2 which can move while holding the substrate 1. The substrate stage 2 moves on a base surface plate 4. The imprint head 3 is fixed to a bridge surface plate 12 supported by the base surface plate 4 through a support member (not shown). The dispensing unit 7 can be driven by a driving unit 8 supported by the bridge surface plate 12.

The mold 5 is generally manufactured by using a material capable of transmitting ultraviolet light, such as quartz. A concave-convex pattern to be transferred onto the substrate 1 is formed in a partial region (pattern region) on the substrate-side surface of the mold 5. In addition, as the substrate 1, it is possible to use, for example, a single-crystal silicon substrate or SOI (Silicon on Insulator) substrate. The dispensing unit 7 supplies an imprint material onto the upper surface (treatment surface) of the substrate 1.

The imprint head 3 includes a mold holding unit 3a which holds a mold with, for example, a vacuum suction force or electrostatic force and a mold driving unit 3c which drives the mold holding unit 3a in the Z direction via a support member 3b. The imprint head 3 may have an adjustment function of adjusting the position of the mold 5 in the X and Y directions and the θ direction (the rotational direction around the Z-axis) and a tilt function of correcting the tilt of the mold 5 as well as the function of driving the mold 5 in the Z direction. The substrate stage 2 includes a substrate chuck 2a which holds the substrate 1 with, for example, a vacuum suction force or electrostatic force and a substrate driving unit 2b configured to move while mechanically holding the substrate chuck 2a. The substrate stage 2 performs alignment of the substrate 1 in the X and Y directions. The substrate stage 2 may have a function of moving the substrate 1 in the Z direction and an adjustment function of adjusting the position of the substrate 1 in the θ direction as well as a function of moving the substrate 1 in the X and Y directions. In the imprint unit 10 according to this embodiment, the imprint head 3 changes the distance between the mold 5 and the substrate 1. However, this is not exhaustive. The substrate stage 2 may perform this operation or both of them may relatively perform the operation.

The irradiation unit 6 cures an imprint material on a substrate by irradiating the imprint material with light. The irradiation unit 6 can include, for example, a light source which emits light (ultraviolet light) for curing an imprint material and an optical element for adjusting the light emitted from the light source into light suitable for an imprint process. In this case, since the first embodiment uses the photo-curing method, the irradiation unit 6 can include a light source which emits ultraviolet light. If, for example, the embodiment uses a heat curing method, a heat source for curing a thermosetting resin as an imprint material can be used in place of a light source. The alignment measurement unit 9 detects the positional shift between a mark provided on the mold 5 and a mark provided on the substrate 1, and measures the relative positions of a pattern region of the mold 5 and a shot region on a substrate onto which a pattern on the mold 5 is to be transferred.

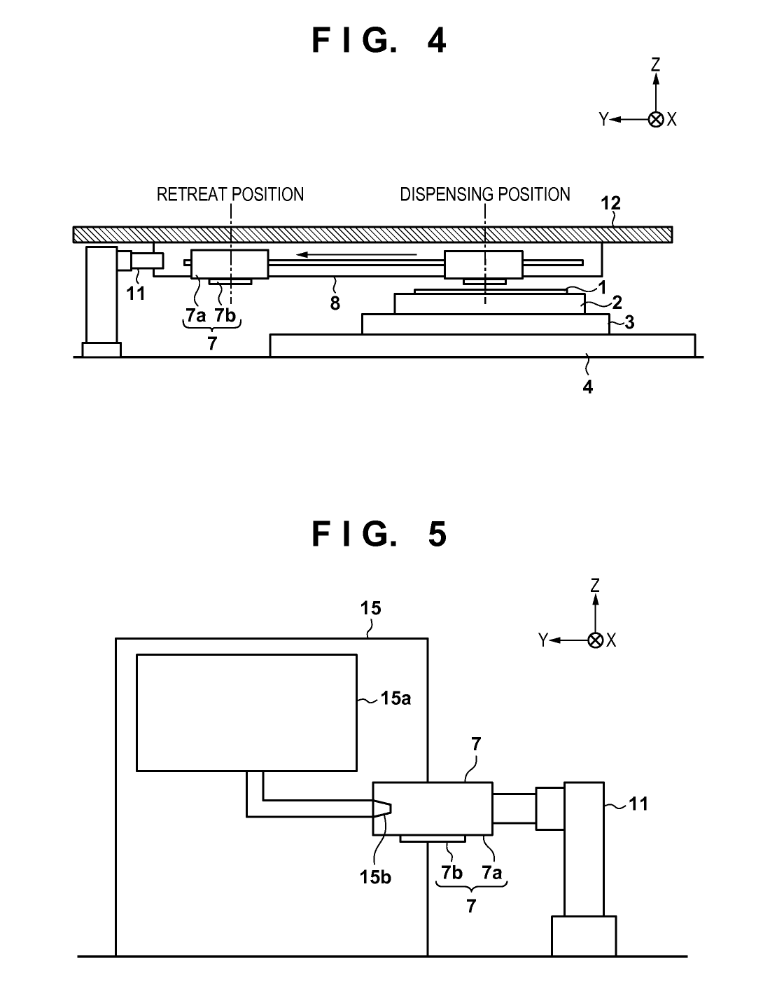

As shown in FIG. 3, the dispensing unit 7 includes the tank 7a containing an imprint material and a dispenser 7b including a plurality of nozzles which discharge the imprint material contained in the tank 7a to the substrate 1, and supplies the imprint material onto a substrate. FIG. 3 is a view showing a cross-section of the dispensing unit 7. In addition, as shown in FIG. 4, the dispensing unit 7 is driven by the driving unit 8 between a dispensing position at which the dispensing unit 7 is arranged when dispensing an imprint material on a substrate and a retreat position. At the retreat position, the supply unit 15 supplies an imprint material to the tank 7a, and the exchanging unit 16 exchanges the dispensing unit 7.

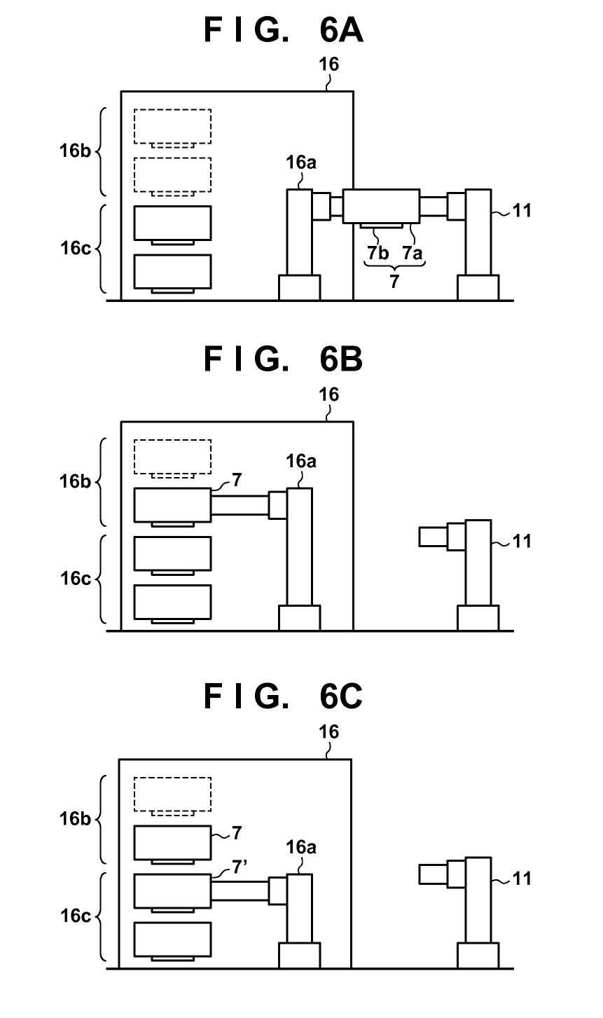

The dispensing unit 7 arranged at the retreat position is held by an arm 11 in the imprint unit 10. The arm 11 is configured to convey the dispensing unit 7 between the retreat position in the imprint unit 10 and the supply unit 15 and the exchanging unit 16. When the supply unit 15 is to supply an imprint material to the tank 7a of the dispensing unit 7, the arm 11 conveys the dispensing unit 7 to the front of the supply unit 15, and connects the dispensing unit 7 to the supply unit 15 as shown in FIG. 5. The supply unit 15 includes, for example, a tank 15a containing an imprint material and a supply port 15b for letting the imprint material flow in the tank 7a. The supply unit 15 then supplies the imprint material contained in the tank 15a of the supply unit 15 to the tank 7a of the dispensing unit 7 connected to the supply port 15b. The dispensing unit 7 to which the imprint material is supplied by the supply unit 15 is conveyed to the retreat position by the arm 11 and connected to the driving unit 8. On the other hand, when the exchanging unit 16 is to exchange the dispensing unit 7, the arm 11 conveys the dispensing unit 7 to the front of the exchanging unit 16, and delivers the dispensing unit 7 to an arm 16a of the exchanging unit 16 as shown in FIG. 6A. The arm 16a of the exchanging unit 16 then places the dispensing unit 7 in a first storage cabinet 16b of the exchanging unit 16 as shown in FIG. 6B, and holds a new dispensing unit 7′ stored in a second storage cabinet 16c and having a tank 7a filled with an imprint material as shown in FIG. 6C. The arm 16a then delivers the new dispensing unit 7′ to the arm 11. The new dispensing unit 7′ is conveyed to the retreat position by the arm 11 and then connected to the driving unit 8.

In addition, the forming unit 14 forms an adhesion layer which makes the substrate 1 adhere to an imprint material so as to stably dispense the imprint material on the substrate 1 while ensuring the adhesion between the substrate 1 and the imprint material. The forming unit 14 includes, for example, a spin coater and can form an adhesion layer on the substrate 1 by supplying an adhesive, which makes the substrate 1 adhere to the imprint material, to the substrate while rotating the substrate 1. The substrate 1 on which the adhesion layer is formed by the forming unit 14 is conveyed to each imprint unit 10 by the conveying unit 13.

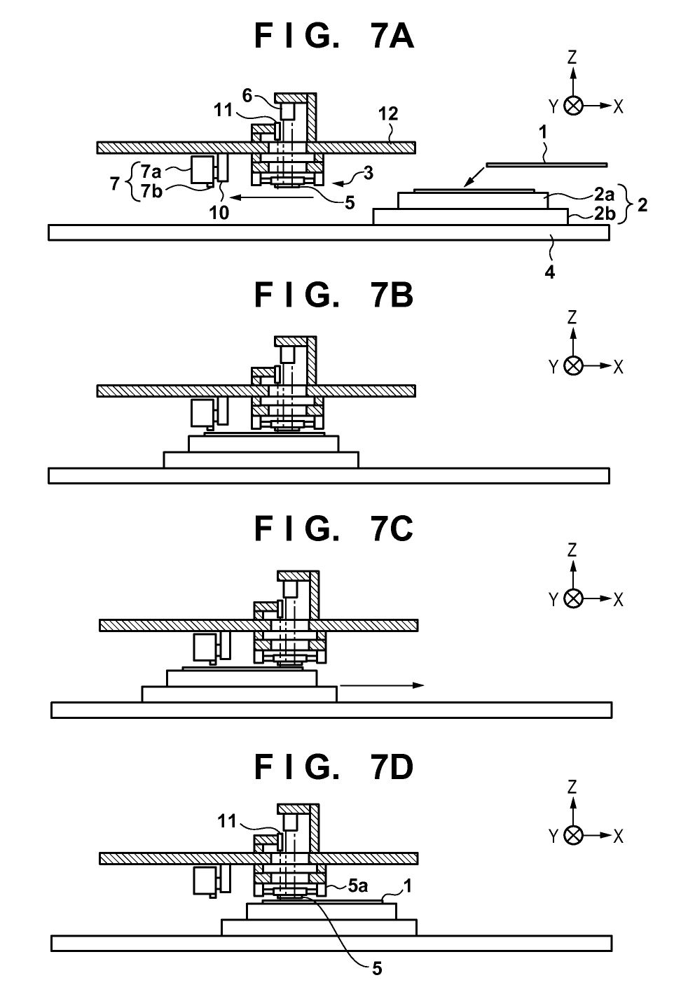

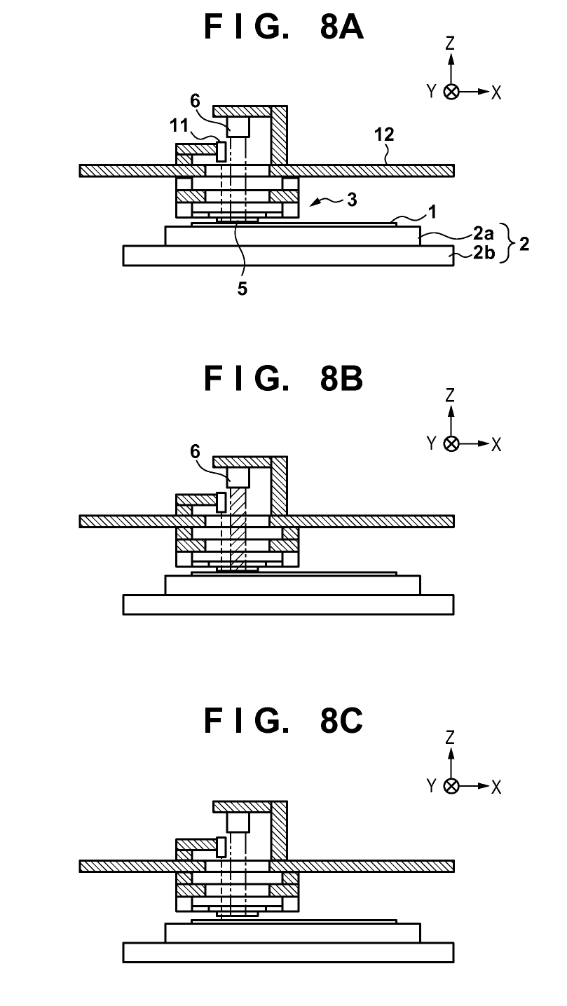

A procedure for an imprint process in the imprint apparatus 100 according to the first embodiment will be described next with reference to FIGS. 7A to 7D and 8A to 8C. When the substrate 1 on which the adhesion layer is formed by the forming unit 14 is held by the substrate stage 2, the control unit 17 controls the substrate stage 2 to locate a shot region on the substrate onto which a pattern of the mold 5 is to be transferred below the dispensing unit 7, as shown in FIG. 7A. When the shot region is located below the dispensing unit 7, the control unit 17 controls the dispensing unit 7 to supply an imprint material to the shot region, as shown in FIG. 7B. After the dispensing unit 7 supplies the imprint material to the shot region, the control unit 17 controls the substrate stage 2 to locate the shot region on the substrate below the pattern region of the mold 5, as shown in FIG. 7C. When the shot region is located below the pattern region, the control unit 17 controls the imprint head 3 to move the mold 5 in the -Z direction so as to bring the pattern region of the mold 5 into contact with the imprint material on the substrate, as shown in FIG. 7D. The control unit 17 then keeps the mold 5 in contact with the imprint material on the substrate for a predetermined time. This makes it possible to completely fill the pattern formed on the mold 5 with the imprint material on the substrate.

As shown in FIG. 8A, the control unit 17 causes the alignment measurement unit 9 to measure the relative positions of the pattern region of the mold 5 and the shot region on the substrate while keeping the mold 5 in contact with the imprint material on the substrate. After the measurement by the alignment measurement unit 9, the control unit 17 performs alignment between the pattern region of the mold 5 and the shot region on the substrate based on the measurement result. After the alignment between the pattern region and the shot region, the control unit 17 controls the irradiation unit 6 to irradiate the imprint material on the substrate with light (ultraviolet light) through the mold 5, as shown in FIG. 8B. As shown in FIG. 8C, the control unit 17 then controls the imprint head 3 to move the mold 5 in the +Z direction, and separates the mold 5 from the imprint material on the substrate which is cured by the irradiation with light. This makes it possible to transfer the pattern of the mold 5 onto the imprint material on the substrate. The above imprint process is performed for each of the plurality of shot regions on the substrate.

The imprint apparatus 100 having the above arrangement may start a dispensing process while a predetermined time elapses after the formation of an adhesion layer on a substrate by the forming unit 14. This is because the function of making the substrate 1 adhere to the imprint material by using the adhesion layer formed on the substrate can deteriorate with the lapse of time. If, however, a shortage of an imprint material in the tank 7a occurs during the repetition of an imprint process for one substrate, it is necessary to interrupt the imprint process and make the supply unit 15 supply an imprint material to the tank 7a or make the exchanging unit 16 exchange the dispensing unit 7. In this case, after the imprint process is resumed, it is not possible to start a dispensing process while a predetermined time elapses after the formation of an adhesion layer on the substrate by the forming unit 14, and hence it can be difficult to accurately form the pattern formed from the imprint material. That is, it may become difficult to accurately form the pattern formed from an imprint material throughout one substrate. For this reason, the imprint apparatus 100 according to the first embodiment is provided with a detection unit 7c which detects the remaining amount of imprint material contained in the tank 7a of the dispensing unit 7, and the control unit 17 operates based on the detection result obtained by the detection unit 7c.

The dispensing unit 7 includes the detection unit 7c which detects the remaining amount of imprint material contained in the tank 7a. The detection unit 7c can detect the remaining amount of imprint material by sensing the position of the liquid surface of the imprint material contained in the tank 7a based on, as a sensing principle, the difference in volume resistivity or dielectric constant between the imprint material and air. For example, as shown in FIG. 3, the detection unit 7c is formed by arraying a plurality of sensors 7c₁ along the Z direction, which output a signal when the liquid surface of an imprint material is arranged at them. The detection unit 7c having this arrangement can detect the remaining amount of imprint material contained in the tank 7a based on the position (Z direction) of the sensors 7c₁ which output a signal.

Based on the detection result obtained by the detection unit 7c, the control unit 17 performs control to supply an imprint material to the tank 7a or exchange the dispensing unit 7 so as to prevent a shortage of an imprint material during the repetition of an imprint process with respect to one substrate 1. In the first embodiment, the control unit 17 decides the number of substrates on which an imprint material can be dispensed by the dispensing unit 7, based on the detection result obtained by the detection unit 7c (the remaining amount of imprint material contained in the tank 7a). The control unit 17 then specifies a substrate to be subjected to a shortage of an imprint material based on the decided number of substrates, and causes the supply unit 15 to supply an imprint material before the start of a dispensing process for the specified substrate, or causes the exchanging unit 16 to exchange the dispensing unit 7. In this case, the number of substrates can be decided by dividing “the remaining amount of imprint material contained in the tank 7a” by “the amount of imprint material used for one substrate”. In addition, it is possible to use, as “the amount of imprint material used for one substrate”, for example, the average value of the amounts of imprint material which has been used for a plurality of substrates subjected to imprint processes.

Assume that the control unit 17 has decided the number of substrates on which the dispensing unit 7 can dispense an imprint material as a number n (n is a natural number) based on the detection result obtained by the detection unit 7c, and specified the nth substrate as a substrate for which an imprint process is to be performed as a substrate to be subjected to a shortage of imprint material. In this case, the control unit 17 causes the supply unit 15 to supply an imprint material or the exchanging unit 16 to exchange the dispensing unit 7 before the start of an imprint process (dispersing process) for the nth substrate. The above supply or exchange may be performed after the end of an imprint process for the (n−1)th substrate and before the start of an imprint process for the nth substrate. However, this is not exhaustive. This operation may be performed at any timing before the start of the imprint process for the nth substrate and between imprint processes for the respective substrates. That is, the operation may be performed after an imprint process for the (n−2)th substrate and before the start of an imprint process for the (n−1)th substrate.

In addition, if the supply unit 15 supplies an imprint material or the exchanging unit 16 exchanges the dispensing unit 7 after the forming unit 14 forms an adhesion layer on a substrate, it can be difficult to start a dispensing process by the dispensing unit 7 before the lapse of a predetermined time. For this reason, the control unit 17 may control the forming unit 14 so as to complete a forming process for an adhesion layer on a substrate specified as a substrate to be subjected to a shortage of an imprint material after the shortage of an imprint material is solved. The solution of the shortage of an imprint material can include the supply of an imprint material by the supply unit 15 and the exchange of the dispensing unit 7 by the exchanging unit 16. This makes it possible to start a dispensing process by the dispensing unit 7 before the lapse of a predetermined time after an adhesion layer is formed on a substrate specified as a substrate to be subjected to a shortage of an imprint material.

As described above, the imprint apparatus 100 according to the first embodiment includes the detection unit 7c which detects the remaining amount of imprint material contained in the tank 7a. The imprint apparatus 100 performs control, based on the detection result obtained by the detection unit 7c, to supply an imprint material to the tank 7a or exchange the dispensing unit 7 so as to prevent a shortage of an imprint material during the repetition of an imprint process for the substrate 1. This makes it possible to start a dispensing process using an imprint material before the lapse of a predetermined time after the formation of an adhesion layer on a substrate by the forming unit 14. It is therefore possible to accurately form a pattern formed from the imprint material on the substrate. In this case, in the first embodiment, the control unit 17 may be configured to notify the user of the number of substrates on which an imprint material can be dispensed by the dispensing unit 7. If, for example, the imprint apparatus 100 is provided with a display unit such as a display, the control unit 17 performs this notification by displaying the decided number of substrates on the display unit. In this case, the control unit 17 may be configured to perform only the notification or may be configured to control the supply of an imprint material by the supply unit 15, the exchange of the dispensing unit 7 by the exchanging unit 16, and the formation of adhesion layer by the forming unit 14 as well as performing the notification.

### Second Embodiment

The first embodiment has exemplified the case in which an imprint process is controlled based on the detection result obtained by the detection unit 7c so as to prevent a shortage of an imprint material during the repetition of an imprint process for one substrate. However, in a manufacturing process for a semiconductor device or the like, a forming process for an adhesion layer by a forming unit 14 and an imprint process are sometimes controlled for each lot including a plurality of substrates instead of one substrate. For example, after a forming process is performed for one lot, an imprint process can be performed for the one lot. However, if a shortage of an imprint material occurs during the repletion of an imprint process for one lot, it is necessary to interrupt the imprint process and supply an imprint material or exchange the dispensing unit 7. In this case, after an imprint process is resumed, a dispensing process for some substrate in the lot cannot be started while a predetermined time elapses after the formation of an adhesion layer on the substrate by the forming unit 14. That is, it can be difficult to accurately form patterns formed from an imprint material throughout one lot. For this reason, in an imprint apparatus according to the second embodiment, a control unit 17 performs control, based on the detection result obtained by the detection unit 7c, to supplement an imprint material to a dispensing unit 7 so as to prevent a shortage of an imprint material during the repetition of an imprint process for one lot. In this case, the imprint apparatus according to the second embodiment has the same apparatus arrangement as that of the imprint apparatus 100 according to the first embodiment, and hence a description of the apparatus arrangement will be omitted below.

The control unit 17 decides the number of substrates on which an imprint material can be dispensed by the dispensing unit 7 based on the detection result obtained by the detection unit 7c. The control unit 17 then specifies a lot to be subjected to a shortage of an imprint material based on the decided number of substrates, and and causes a supply unit 15 to supply an imprint material before the start of a dispensing process for the specified lot, or causes an exchanging unit 16 to exchange a dispensing unit 7. Assume that the control unit 17 has specified the mth lot as a lot to be subjected to a shortage of imprint material based on the number of substrates on which an imprint material can be dispensed by the control unit 17. In this case, the control unit 17 causes the supply unit 15 to supply an imprint material or the exchanging unit 16 to exchange the dispensing unit 7 before the start of an imprint process for the mth lot. Although the supply or exchange may be performed after the end of an imprint process for the (m−1)th lot and before the start of an imprint process for the mth lot, this is not exhaustive. This operation may be performed at any timing before the start of the imprint process for the mth lot and between imprint processes for the respective lots. That is, the operation may be performed after an imprint process for the (m−2)th lot and before the start of an imprint process for the (m−1)th lot.

In addition, the control unit 17 may control the forming unit 14 so as to complete a forming process for an adhesion layer on a lot specified as a lot to be subjected to a shortage of an imprint material after the shortage of an imprint material is solved. The solution of the shortage of an imprint material can include the supply of an imprint material by the supply unit 15 and the exchange of the dispensing unit 7 by the exchanging unit 16. This makes it possible to start a dispensing process by the dispensing unit 7 before the lapse of a predetermined time after an adhesion layer is formed by the forming unit 14 on each of the plurality of substrates included in a lot specified as a lot to be subjected to a shortage of an imprint material.

As described above, the imprint apparatus according to the second embodiment performs control, based on the detection result obtained by the detection unit 7c, to supply an imprint material to the tank 7a or exchange the dispensing unit 7 so as to prevent a shortage of an imprint material during the repetition of an imprint process for one lot. This makes it possible to start a dispensing process using an imprint material before the lapse of a predetermined time after the formation of an adhesion layer on each of the plurality of substrates included in one lot by the forming unit 14. It is therefore possible to accurately form a pattern formed from the imprint material on each substrate included in the one lot.

### Embodiment of Method of Manufacturing Article

A method of manufacturing an article according to an embodiment of the present invention is suitable for manufacturing an article, for example, a microdevice such as a semiconductor device or an element having a microstructure. The method of manufacturing the article according to this embodiment includes a step of forming a pattern on a resin applied to a substrate using the above-described imprint apparatus (a step of performing an imprint process on the substrate), and a step of processing the substrate onto which the pattern has been formed in the preceding step. This manufacturing method further includes other known steps (oxidation, deposition, vapor deposition, doping, planarization, etching, resist peeling, dicing, bonding, packaging, and the like). The method of manufacturing the article according to this embodiment is advantageous in at least one of the performance, the quality, the productivity, and the production cost of the article, as compared to a conventional method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-136214 filed Jul. 1, 2014, which is hereby incorporated by reference herein in its entirety.

What is claimed is:

1. An imprint apparatus which performs an imprint process of dispensing an imprint material on a substrate and forming the imprint material dispensed on the substrate by using a mold, the apparatus comprising:
a dispensing unit configured to dispense an imprint material on the substrate, and including a tank which contains an imprint material, a dispenser which discharges the imprint material contained in the tank to the substrate, and a detection unit which detects a remaining amount of imprint material contained in the tank; and
a control unit configured to perform control to supply an imprint material to the tank or exchange the dispensing unit based on a detection result obtained by the detection unit.

2. The apparatus according to claim 1, further comprising a supply unit configured to supply an imprint material to the tank,
wherein the supply unit supplies an imprint material to the tank based on a detection result obtained by the detection unit.

3. The apparatus according to claim 1, further comprising an exchange unit configured to exchange the dispensing unit,
wherein the exchange unit exchanges the dispensing unit based on a detection result obtained by the detection unit.

4. The apparatus according to claim 1, wherein the control unit performs the control, based on a detection result obtained by the detection unit, so as to prevent a shortage of an imprint material in the tank during repetition of an imprint process for one substrate or one lot.

5. The apparatus according to claim 4, further comprising a supply unit configured to supply an imprint material to the tank,
wherein the control unit specifies a substrate or a lot to be subjected to a shortage of an imprint material in the tank based on a detection result obtained by the detection unit, and causes the supply unit to supply an imprint material to the tank before a start of dispensing of an imprint material by the dispensing unit for the specified substrate or the specified lot.

6. The apparatus according to claim 4, further comprising an exchange unit configured to exchange the dispensing unit,
wherein the control unit specifies a substrate or a lot to be subjected to a shortage of an imprint material in the tank based on a detection result obtained by the detection unit, and causes the exchange unit to exchange the dispensing unit before a start of dispensing of an imprint material by the dispensing unit for the specified substrate or the specified lot.

7. The apparatus according to claim 4, further comprising a forming unit configured to form, on a substrate, an adhesion layer for making the substrate adhere to an imprint material,
wherein the control unit specifies a substrate or a lot to be subjected to a shortage of an imprint material in the tank based on a detection result obtained by the detection unit, and controls the forming unit to complete formation of the adhesion layer on the specified substrate or the specified lot after the shortage of an imprint material is solved.

8. The apparatus according to claim 7, wherein the control unit determines the number of substrates on which an imprint material is configured to be dispensed by the dispensing unit based on a detection result obtained by the detection unit, and specifies a substrate or a lot to be subjected to a shortage of an imprint material in the tank based on the determined number.

9. The apparatus according to claim 1, wherein the detection unit detects the remaining amount by detecting a position of a liquid surface of an imprint material contained in the tank.

10. The apparatus according to claim 1, wherein the control unit provides a notification of the number of substrates on which an imprint material is configured to be dispensed by the dispensing unit based on a detection result obtained by the detection unit.

11. A method of manufacturing an article, the method comprising steps of:
forming a pattern on a substrate using an imprint apparatus; and
processing the substrate, on which the pattern has been formed, to manufacture the article,
wherein the imprint apparatus performs an imprint process of dispensing an imprint material on a substrate and forming the imprint material dispensed on the substrate by using a mold and includes:
a dispensing unit configured to dispense an imprint material on the substrate, and including a tank which contains an imprint material, a dispenser which discharges the imprint material contained in the tank to the substrate, and a detection unit which detects a remaining amount of imprint material contained in the tank; and
a control unit configured to perform control to supply an imprint material to the tank or exchange the dispensing unit based on a detection result obtained by the detection unit.

12. An imprint system which forms an imprint material on a substrate by using a mold on which a pattern is formed, the system comprising:
an imprint apparatus including a dispensing unit which dispenses, on a substrate, an imprint material contained in a tank and configured to form the imprint material dispensed on the substrate by the dispensing unit by using the mold;
a forming apparatus configured to form, on a substrate, an adhesion layer for making the substrate adhere to the imprint material; and
a control unit,
wherein the dispensing unit includes a detection unit which detects a remaining amount of imprint material contained in the tank, and
the control unit specifies a substrate or a lot to be subjected to a shortage of an imprint material in the tank based on a detection result obtained by the detection unit, and controls the forming apparatus to complete formation of an adhesion layer on the substrate or the lot after the shortage of an imprint material is solved.
